(19) United States
(12) Patent Application Publication
(10) Pub. No.: US 2008/0180471 A1
(43) Pub. Date: Jul. 31, 2008

(54) APPARATUS TO CONTROL HEATER IN INK JET PRINTER HEAD AND METHOD THEREOF

(75) Inventor: Eun Bong HAN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/952,390

(22) Filed: Dec. 7, 2007

(30) Foreign Application Priority Data
Jan. 30, 2007 (KR) 2007-9483

(51) Int. Cl. B41J 29/38

(52) U.S. Cl. 347/9

(57) ABSTRACT

An apparatus to control a heater in an ink jet printer head. The apparatus to control the heater in an ink jet printer head includes a limit circuit to generate a limit pulse to limit a strobe pulse such that a maximum driving time of the heater is limited to an abnormal input of a system clock which is provided from the printer body. The maximum driving time of the heater is limited even when an erroneous serial clock signal pulse is input due to an abnormal operation of the printer body in a printing operation to prevent breakdown of the heater.

### CROSS-REFERENCE TO RELATED APPLICATIONS

This application claims the priority under 35 U.S.C. § 119(a) from Korean Patent Application No. 2007-9483, filed on Jan. 30, 2007, in the Korean Intellectual Property Office, the disclosure of which is incorporated herein in its entirety by reference.

### BACKGROUND OF THE INVENTION

1. Field of the Invention

The present general inventive concept relates to an apparatus to control a heater in an ink jet printer head, and more particularly to an apparatus to control a heater in an ink jet printer head to prevent a breakdown of the heater, which may occur due to an abnormal operation of a printer body, and a method thereof.

2. Description of the Related Art

In an ink jet type printer, a heater driving signal from a printer body is transmitted to a printer head having a head chip through a serial communication.

As illustrated in FIG. 1, a printer head chip HC1 of a printer head includes an input data processor 10 for processing data by discriminating whether data received from a printer body is printing data or common data for setting up the state of the head chip HC1, a heater controller 100 including a printing data processor 100A for receiving and processing printing data input from the input data processor 10 and a heater driver 100B for driving heaters to allow ink to be ejected, a strobe pulse generator 20 for generating a strobe pulse for heater driving by counting serial clocks received from the printer body, and an ink passage (not illustrated) for storing ink which is ejected to an area outside of the head chip by bubble pressure which is produced due to the heater driving.

If serial data transmitted from the printer body through a serial communication is printing data, the input data processor 10 divides the serial data into an address and primitive data to transmit them to the heater controller 100 for controlling a corresponding heater to be driven. If serial data which is transmitted from the printer body through a serial communication is common data, the input data processor 10 analyzes the common data to set up the head chip and a corresponding register of the strobe pulse generator 20.

The strobe pulse generator 20 generates a strobe pulse for heater driving by counting serial clocks which are synchronized with a load signal LOAD, and transmits the strobe pulse to the heater generator 100.

The heater controller 100 includes the printing data processor 100A and the heater driver 100B. The heater controller 100 analyzes serial data which is transmitted from the printer body to selectively drive a plurality of heaters.

As illustrated in FIG. 2, the primitive data P_Data and the address ADDR are configured as serial signal lines for the purpose of simply designing a system.

An m-bit shift register 103 and an n-bit shift register 106 respectively receive the primitive data P_Data and the address ADDR which are synchronized with a clock CLOCK to select a nozzle corresponding to a respective heater.

If a load signal LOAD is input, an m-bit latch circuit 104 and an n-bit latch circuit 105 respectively latch the primitive data P_Data and the address ADDR which are provided from the m-bit shift register 103 and the n-bit shift register 106, respectively.

If a strobe pulse STRB is input to allow ink to be ejected, each of a plurality of m-bit latch signals P1 through Pm and n-bit latch signals A1 through An turns on a transistor (or FET) 102 of a corresponding nozzle through an AND gate 101, and a driving voltage Vph is applied to thermal elements of the nozzle to allow a current to flow, thereby ejecting ink stored in the ink passage (not illustrated).

Since respective data is latched to the AND gate 101 only when a load signal LOAD is input as illustrated in FIG. 3, the nozzles which are driven by a first strobe pulse STRB_1 are nozzles corresponding to first data Data_1, and the nozzles which are driven by a second strobe pulse STRB_2 are nozzles corresponding to second data Data_2. A heater current is determined depending on a pulse width of the first strobe pulse STRB_1 and the second strobe pulse STRB_2.

According to the prior art, a printer head receives serial clock signals CLOCK, serial data P_Data, load signals LOAD, etc, which are input from a printer body through serial communications in order to drive a heater for ink ejection in the printer head.

Since a signal which is transmitted from the printer body should be synchronized with a serial clock and then transmitted, a head controller for generating the serial clock in the printer body must have a complicated logic circuit to set a timing of the signal.

However, a printer body may be influenced by electro-magnetic susceptibility (EMS) during a printing operation. Therefore, for example, a system may be latched up by being exposed to static electricity or similar outside influences, or a serial clock may be stopped or the period of the serial clock may be changed due to an abnormal operation of a head controller in the printer body.

If an abnormal phenomenon described above occurs in a process of generating a strobe pulse STRB for counting serial clocks transmitted from a printer body to control time for which a current flows into a heater, i.e., if an abnormal phenomenon occurs in that a serial clock is stopped during counting clocks, an enable state is maintained in the strobe pulse STRB. Therefore, there occurs a problem in that the heater may break down as the heater is continuously driven for a long period of time. If the heater breaks down as the heater is continuously driven for a long period of time, ink cannot be ejected from a corresponding nozzle. As a result, printing quality is degraded.

Considering such problems, a strobe pulse is generated by counting clocks for driving a heater independently from a head controller of a printer body. Accordingly, if the strobe pulse is applied, the aforementioned problems can be solved. However, the driving frequency of the clock cannot be increased as compared with a serial clock which is provided from the printer body due to the influence of EMS. Further, the clock is not synchronized with the serial data and the serial clock, which are provided from the printer body. For these reasons, there is a problem in that it is difficult to precisely adjust the pulse width of a strobe pulse.

### SUMMARY OF THE INVENTION

The present general inventive concept provides an apparatus to control a heater in an ink jet printer head to prevent a breakdown of the heater by limiting a strobe pulse when a plurality of serial clock signal pulses or other signals are input from a printer body.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing an apparatus to control a heater in an ink jet printer head having a printer head chip to drive the heater through a serial communication with a printer body, the apparatus including an input data processor to process data input from the printer body, a controller to control the heater to be driven by using data provided to drive heater from the input data processor and a strobe pulse to set a driving time of the heater, a strobe pulse generator to synchronize system clock pulses with a load signal provided from the printer body to generate the strobe signal, and a limit circuit to limit the pulse width of the strobe pulse from the strobe pulse generator.

The limit circuit may be limited within the maximum driving time of the heater.

The limit circuit may include a memory to store a reference value corresponding to the maximum allowed time of the heater.

The limit circuit may include a strobe pulse width limiter to generate a limit pulse to limit the pulse width of the strobe pulse, and an AND gate to perform an AND operation with respect to the strobe pulse from the strobe pulse generator and the limit signal from the strobe pulse width limiter to output a limited strobe pulse.

The strobe pulse width limiter may generate the limit signal by being synchronized with the strobe pulse output from the strobe pulse generator.

The strobe pulse width limiter may count limiter clock pulses generated independently from the system clock pulses and may be provided from the printer body to generate the limit pulse.

The pulse width of the limit signal may be generated not to be narrower than that of the limited strobe pulse.

The foregoing and/or other aspects and utilities of the present general inventive concept may also be achieved by providing an apparatus to control a heater in an ink jet printer, including a printer body, an input data processor to process data to drive the heater through a serial communication with the printer body, a controller to control the heater to be driven by using data provided to drive heater from the input data processor and a strobe pulse to set the driving time of the heater, a strobe pulse generator to synchronize system clock pulses with a load signal provided from the printer body to generate the strobe signal, a memory to store a reference value corresponding to a maximum driving time of the heater, a limit pulse generator to generate a limit signal to limit the strobe pulse from the strobe pulse generator within the reference value, and an operator to perform a logic operation with respect to the strobe pulse from the strobe pulse generator and the limit signal from the limit pulse generator to provide the limited strobe pulse to the heater controller.

The limit pulse generator may count second clock signal pulses provided from the printer body independently from the first clock signal pulses to generate a limit pulse.

The operator may be an AND gate.

The foregoing and/or other aspects and utilities of the present general inventive concept may also be achieved by providing an apparatus to control a heater in an ink jet printer head, the apparatus including a strobe pulse generator to generate a strobe pulse, a limit circuit to limit a pulse width of the strobe pulse, and a controller to drive the heater to eject ink based on the limited pulse width of the strobe pulse.

The strobe pulse from the strobe pulse generator may be based on serial clock signal pulses from a serial clock.

The limit circuit may limit the pulse width of the strobe pulse during an abnormal operation of the serial clock.

The limit circuit may limit the pulse width of the strobe pulse based on a maximum driving time of the heater.

The limit circuit may output a limit pulse to limit the pulse width of the strobe pulse.

The apparatus may further include an operator to output a limited strobe pulse based on the strobe pulse from the strobe pulse generator and the limit pulse from the limit circuit to the controller.

The controller may drive the heater to eject the ink based on the limited strobe pulse output from the operator.

The foregoing and/or other aspects and utilities of the present general inventive concept may also be achieved by providing an apparatus to control a heater in an ink jet printer head, the apparatus including a serial clock to output a serial clock pulse signal, and a controller to drive the heater to eject ink based on an abnormal behavior of the serial clock pulse signal.

The apparatus may further include a strobe pulse generator to generate a strobe pulse based on the serial clock pulse signal, and a limit circuit to detect the abnormal behavior of the serial clock pulse signal based on a pulse width of the strobe pulse.

The limit circuit may limit the pulse width of the strobe pulse and outputs the limited strobe pulse to the controller.

The foregoing and/or other aspects and utilities of the present general inventive concept may also be achieved by providing a method of controlling a heater in an ink jet printer head having a printer head chip to drive the heater through a serial communication with a printer body, the method including processing data input from the printer body, generating a strobe pulse by synchronizing a system clock pulse with a load signal provided from the printer body, limiting a pulse width of the strobe pulse, and controlling the heater to be driven by using the input data and the limited strobe pulse to set a driving time of the heater.

The foregoing and/or other aspects and utilities of the present general inventive concept may also be achieved by providing a method of controlling a heater in an ink jet printer head, the method including generating a strobe pulse, limiting a pulse width of the strobe pulse, and driving the heater to eject ink based on the limited pulse width of the strobe pulse.

The strobe pulse may be based on serial clock signal pulses from a serial clock.

The limiting of the pulse width of the strobe pulse may occur during an abnormal operation of the serial clock.

The limiting of the pulse width of the strobe pulse may be based on a maximum driving time of the heater.

The foregoing and/or other aspects and utilities of the present general inventive concept may also be achieved by providing a method of controlling a heater in an ink jet printer head, the method including outputting a serial clock pulse signal, and driving the heater to eject ink based on an abnormal behavior of the serial clock pulse signal.

The method may further include generating a strobe pulse based on the serial clock pulse signal, and detecting the abnormal behavior of the serial clock pulse signal based on a pulse width of the strobe pulse.

The method may further include limiting the pulse width of the strobe pulse, and outputting the limited strobe pulse to the controller.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating a conventional configuration of an ink jet printer head;

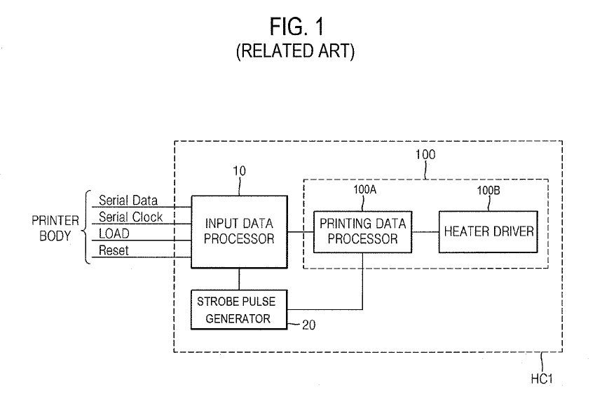

FIG. 2 is a view illustrating a conventional configuration of a heater controller;

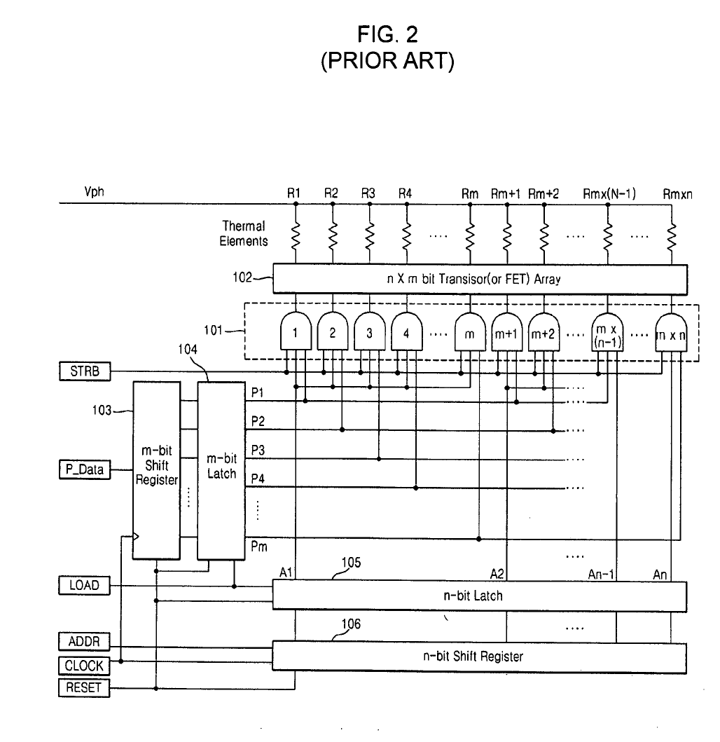

FIG. 3 is a timing diagram illustrating conventional signals which are applied to respective components of the ink jet printer head of FIG. 1;

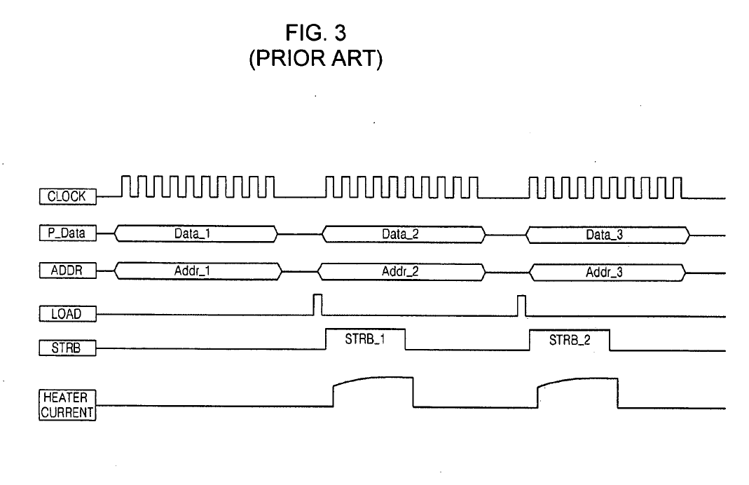

FIG. 4 is a block diagram illustrating a configuration of an apparatus to control a heater in an ink jet printer head according to the present general inventive concept; and

FIG. 5 is a timing diagram illustrating signals applied to respective components according to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

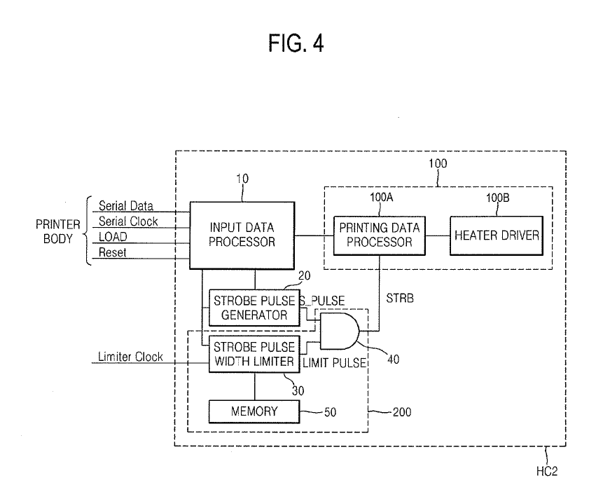

FIG. 4 is a block diagram illustrating a configuration of an apparatus to control a heater in an ink jet printer head according to the present general inventive concept. Since like elements are designated by like reference numerals, the present embodiment will be briefly described. Descriptions overlapping with the aforementioned descriptions will be omitted.

A printer head chip HC2 according to the present general inventive concept includes an input data processor 10 to process data by discriminating whether data received from a printer body is printing data or common data which is used to set up a state of the head chip HC2, a heater controller 100 including a printing data processor 100A to receive and process printing data which is input from the input data processor 10, and a heater driver 100B to drive the heater to allow ink to be ejected, a strobe pulse generator 20 to generate a strobe pulse to drive the heater by counting serial clock pulses which are received from the printer body, and an ink passage (not illustrated) to store ink which is ejected to an area outside of the head chip by bubble pressure which is produced due to the driven heater.

The present general inventive concept includes a limit circuit 200 to generate a limit pulse to limit a strobe pulse such that a maximum driving time of the heater can be limited in an abnormal input of a system clock which is provided from the printer body.

The limit circuit 200 generates the limit pulse by being synchronized with a strobe pulse which is output from the strobe pulse generator 20.

The limit circuit 200 includes a strobe pulse width limiter 30 to receive a limiter clock which is generated from an exterior portion or an interior portion of the limit circuit 200, independently from a serial clock of the printer body, to limit a pulse width of a strobe pulse S_PULSE, and an AND gate 40 to perform an AND operation with respect to a limit pulse LIMIT PULSE which is output from the strobe pulse width limiter 30 and a strobe pulse S_PULSE which is generated from the strobe pulse generator 20 to output a strobe pulse STRB to the heater controller 100 to drive the heater.

The limit circuit 200 may further include a memory 50 to store a reference value which is used to limit the pulse width of the strobe pulse STRB in the strobe pulse width limiter 30. The reference value corresponds to the maximum driving time of the heater.

The strobe pulse width limiter 30 counts a number of limiter clock signal pulses which are input independently from a number of serial clock signal pulses to output a limit pulse LIMIT PULSE which is synchronized with a load signal LOAD.

The strobe pulse generator 20 counts the number of serial clock signal pulses which are input from the printer body to output a strobe pulse S_PULSE corresponding to a proper heater driving time to eject ink.

Accordingly, the limit pulse LIMIT PULSE is set by considering durability of the heater. Further, the limit pulse LIMIT PULSE is set within a reference value which is stored in the memory 50. The reference value may be set to a value which is a little larger than the proper heater driving time.

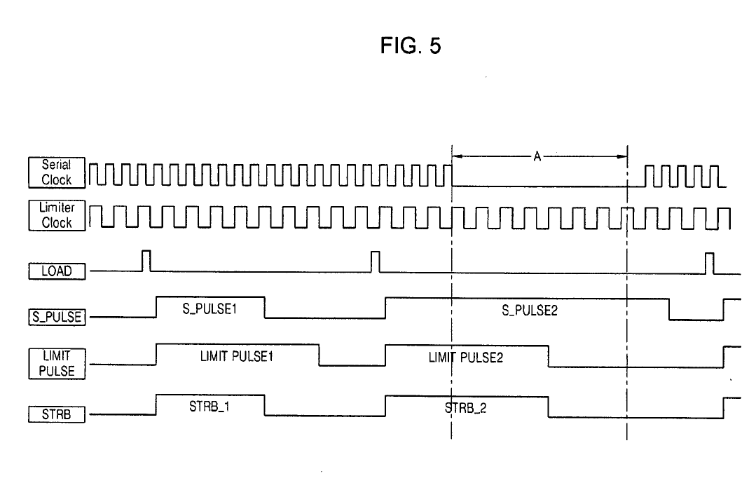

As illustrated in FIG. 5, if a serial clock is stopped for a temporary time A in a printing operation due to an abnormal operation of the printer body, or the like, a strobe pulse S_PULSE2 becomes longer by a time corresponding to a time period where the serial clock has stopped.

At this time, the strobe pulse width limiter 30 outputs a limit pulse LIMIT PULSE 2 which is generated by a limiter clock input independently from the serial clock from the printer body. The AND gate 40 performs an AND operation with respect to the limit pulse LIMIT PULSE 2 and the strobe pulse S_PULSE, and provides a strobe pulse STRB_2 which is limited in accordance with the AND operation to the heater controller 100.

Although an erroneous serial clock signal pulse is provided due to an abnormal operation of the printer body as described above, a strobe pulse is normally generated such that the strobe pulse is not excessively enabled by using a limit pulse which is generated by an independent limit clock.

As described above, according to the present general inventive concept, a maximum driving time of a heater can be limited even when erroneous serial clock pulses are input due to an abnormal operation of a printer body in a printing operation, to prevent a breakdown of the heater.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to control a heater in an ink jet printer head having a printer head chip to drive the heater through a serial communication with a printer body, the apparatus comprising:
an input data processor to process data input from the printer body;
a controller to control the heater to be driven by using data provided to drive the heater from the input data processor and a strobe pulse to set a driving time of the heater;
a strobe pulse generator to generate a strobe pulse by synchronizing system clock pulses with a load signal provided from the printer body; and
a limit circuit to limit a pulse width of the strobe pulse from the strobe pulse generator.

2. The apparatus as claimed in claim 1, wherein the limit circuit is limited within a maximum driving time of the heater.

3. The apparatus as claimed in claim 2, wherein the limit circuit includes a memory to store a reference value corresponding to the maximum driving time of the heater.

4. The apparatus as claimed in claim 2, wherein the limit circuit comprises:
a strobe pulse width limiter to generate the limit pulse to limit the pulse width of the strobe pulse; and
an AND gate to perform an AND operation with respect to the strobe pulse from the strobe pulse generator and the limit pulse from the strobe pulse width limiter to output a limited strobe pulse.

5. The apparatus as claimed in claim 4, wherein the strobe pulse width limiter generates the limit pulse while being synchronized with the strobe pulse output from the strobe pulse generator.

6. The apparatus as claimed in claim 4, wherein the strobe pulse width limiter counts limiter clock pulses generated independently from the system clock pulses and provided from the printer body to generate the limit pulse.

7. The apparatus as claimed in claim 4, wherein the pulse width of the limit pulse is not narrower than the pulse width of the limited strobe pulse.

8. An apparatus to control a heater in an ink jet printer head, the apparatus comprising:
a strobe pulse generator to generate a strobe pulse;
a limit circuit to limit a pulse width of the strobe pulse; and
a controller to drive the heater to eject ink based on the limited pulse width of the strobe pulse.

9. The apparatus of claim 8, wherein the strobe pulse from the strobe pulse generator is based on serial clock signal pulses from a serial clock.

10. The apparatus of claim 9, wherein the limit circuit limits the pulse width of the strobe pulse during an abnormal operation of the serial clock.

11. The apparatus of claim 8, wherein the limit circuit limits the pulse width of the strobe pulse based on a maximum driving time of the heater.

12. The apparatus of claim 8, wherein the limit circuit outputs a limit pulse to limit the pulse width of the strobe pulse.

13. An apparatus to control a heater in an ink jet printer head, the apparatus comprising:
a serial clock to output a serial clock pulse signal; and
a controller to drive the heater to eject ink based on an abnormal behavior of the serial clock pulse signal.

14. The apparatus of claim 13, further comprising:
a strobe pulse generator to generate a strobe pulse based on the serial clock pulse signal; and
a limit circuit to detect the abnormal behavior of the serial clock pulse signal based on a pulse width of the strobe pulse.

15. The apparatus of claim 14, wherein the limit circuit limits the pulse width of the strobe pulse and outputs the limited strobe pulse to the controller.

16. A method of controlling a heater in an ink jet printer head having a printer head chip to drive the heater through a serial communication with a printer body, the method comprising:
processing data input from the printer body;
generating a strobe pulse by synchronizing a system clock pulse with a load signal provided from the printer body;
limiting a pulse width of the strobe pulse; and
controlling the heater to be driven by using the input data and the limited strobe pulse to set a driving time of the heater.

17. A method of controlling a heater in an ink jet printer head, the method comprising:
generating a strobe pulse;
limiting a pulse width of the strobe pulse; and
driving the heater to eject ink based on the limited pulse width of the strobe pulse.

18. The method of claim 17, wherein the strobe pulse is based on serial clock signal pulses from a serial clock.

19. The method of claim 18, wherein the limiting of the pulse width of the strobe pulse occurs during an abnormal operation of the serial clock.

20. The method of claim 17, wherein the limiting of the pulse width of the strobe pulse is based on a maximum driving time of the heater.

21. A method of controlling a heater in an ink jet printer head, the method comprising
outputting a serial clock pulse signal; and
driving the heater to eject ink based on an abnormal behavior of the serial clock pulse signal.

22. The method of claim 21, further comprising:
generating a strobe pulse based on the serial clock pulse signal; and
detecting the abnormal behavior of the serial clock pulse signal based on a pulse width of the strobe pulse.

23. The method of claim 22, further comprising:
limiting the pulse width of the strobe pulse; and
outputting the limited strobe pulse to the controller.
